(19) United States
(12) Patent Application Publication
(10) Pub. No.: US 2018/0109702 A1
(43) Pub. Date: Apr. 19, 2018

(54) IMAGE PROCESSING APPARATUS AND CONTROL METHOD THEREOF

(71) Applicant: SAMSUNG ELECTRONICS CO., LTD., Suwon-si (KR)

(72) Inventors: Sang-kwon NA, Seoul (KR); Doo-hyun KIM, Seoul (KR); Ki-won YOO, Seoul (KR)

(21) Appl. No.: 15/686,598

(22) Filed: Aug. 25, 2017

(30) Foreign Application Priority Data
Oct. 14, 2016 (KR) 10-2016-0133595

(51) Int. Cl. H04N 1/64; H04N 19/36; H04N 19/124; H04N 19/176; H04N 19/186; H04N 19/19

(52) U.S. Cl. CPC H04N 1/646; H04N 19/36; H04N 19/19; H04N 19/176; H04N 19/186; H04N 19/124

(57) ABSTRACT

An image processing apparatus is provided. The image processing apparatus includes a signal processor and a controller. The signal processor processes an image signal including a plurality of color components. The controller controls the signal processor to perform a color gamut conversion, a domain transform, a quantization processing and an encoding processing with respect to an input image signal, and in response to differences between the color components of the image signal being less than a first critical level, to not perform the color gamut conversion.

### CROSS-REFERENCE TO RELATED APPLICATION

This application is based on and claims priority under 35 U.S.C. § 119 to Korean Patent Application No. 10-2016-0133595, filed on Oct. 14, 2016 in the Korean Intellectual Property Office, the disclosure of which is incorporated by reference herein in its entirety.

### BACKGROUND

### Field

The present disclosure relates generally to an image processing apparatus and a control method thereof, and for example to an image processing apparatus, which to efficiently compress a received image signal, converts the received image signal to another color gamut and then into a digital image signal, and a control method thereof.

### Description of Related Art

As consumption for image contents grows, demands for efficient storage and efficient transmission and reception of images are rising. In particular, when the images are transmitted by wireless, to improve communication efficiency, a technique for efficiently compressing the images is required.

To efficiently compress and transmit the images, a high efficiency video codec (HEVC) as a related art for compression of image contents is known. The HEVC is also called a H.265 or a MPEG-H part2. The HEVC converts a color gamut for a received image signal and compresses the color gamut-converted image signal. If the color gamut of the image signal is converted before compressing the image signal, the image signal can not only be compressed with a high efficiency, but also converted/inverse-converted with more less loss and the signal to noise ratio is also improved.

However, in a specific image, if the color gamut of a corresponding image signal is converted before compressing the corresponding image signal according to the related art, there is a problem in that when the corresponding image signal is restored, due to a characteristic thereof, a color thereof is distorted or an unwanted artifact is magnified.

### SUMMARY

Example embodiments address at least the above problems and/or disadvantages and other disadvantages not described above.

The example embodiments may provide an image processing apparatus, which efficiently compresses an image signal without distorting and/or reducing distortion a color thereof, and a control method thereof.

In accordance with an example aspect of the disclosure, an image processing apparatus is provided, the apparatus including a signal processor configured to process an image signal including a plurality of color components, and a controller configured to control the signal processor to perform a color gamut conversion, a domain transform, a quantization processing and an encoding processing with respect to an input image signal, and in response to differences between the color components of the image signal being less than a first critical level, to not perform the color gamut conversion. Accordingly, the image processing apparatus may efficiently compress the input image signal without distorting or reducing a distortion of a color thereof.

The controller may be configured to, in response to a high frequency component of the image signal exceeding a second critical level, control the signal processor to not perform the color gamut conversion, and to perform the quantization processing.

The controller may be configured to, in response to the differences between the color components of the image signal being less than a third critical level higher than the first critical level and the high frequency component of the image signal exceeding a fourth critical level lower than the second critical level, control the signal processor to not perform the color gamut conversion, and to perform the quantization processing.

The controller may be configured to control the signal processor to, in response to the differences between the color components of the image signal exceeding the first critical level, perform a test for the color gamut conversion, and to determine whether to perform the color gamut conversion based on at least one of: a compression ratio and a signal to noise ratio of the image signal as a result of the performed test.

The apparatus may further include communicator comprising communication circuitry configured to communicate with an external apparatus, and the controller may be configured to control the communicator to transmit the image signal to which the encoding processing is performed, to the external apparatus.

In accordance with another example aspect of the disclosure, an image processing apparatus is provided, the apparatus including a signal processor configured to process an image signal including a plurality of color components, and a controller configured to control the signal processor to perform a color gamut conversion, a domain transform, a quantization processing and an encoding processing with respect to an input image signal, and, in response to a high frequency component of the image signal exceeding a first critical level, to not perform the color gamut conversion. With this, the image processing apparatus may efficiently compress the input image signal without distorting and/or reducing a distortion of a color thereof.

The controller may be configured to, in response to differences between the color components of the image signal being less than a second critical level, control the signal processor to not perform the color gamut conversion, and to perform the quantization processing.

The controller may be configured to, in response to the high frequency component of the image signal exceeding a third critical level lower than the first critical level and the difference between the color components of the image signal being less than a fourth critical level higher than the second critical level, control the signal processor to not perform the color gamut conversion, and to perform the quantization processing.

The controller may be configured to control the signal processor to, in response to the high frequency component of the image signal exceeding the first critical level, perform a test for the color gamut conversion, and to determine whether to perform the color gamut conversion based on at least one of: a compression ratio and a signal to noise ratio of the image signal as a result of the performed test.

The apparatus may further include a communicator comprising communication circuitry configured to communicate with an external apparatus, and the controller may be configured to control the communicator to transmit the image signal to which the encoding processing is performed, to the external apparatus.

In accordance with another example aspect of the disclosure, a method of controlling an image processing apparatus including a signal processor configured to process an image signal having a plurality of color components is provided, the method including performing, by the signal processor, a color gamut conversion, a domain transform, a quantization processing and an encoding processing with respect to an input image signal, and in response to a difference between the color components of the image signal being less than a first critical level, controlling the signal processor to not perform the color gamut conversion. Thus, the image processing apparatus may efficiently compress the input image signal without distorting and/or reducing a distortion of a color thereof.

The method may further include, in response to a high frequency component of the image signal exceeding a second critical level, performing the quantization processing without performing the color gamut conversion.

The method may further include, in response to the differences between the color components of the image signal being less than a third critical level higher than the first critical level and the high frequency component of the image signal exceeding a fourth critical level lower than the second critical level, performing the quantization processing without performing the color gamut conversion.

The method may further include, in response to the differences between the color components of the image signal exceeding the first critical level, performing a test for the color gamut conversion, and determining whether to perform the color gamut conversion based on at least one of a compression ratio and a signal to noise ratio of the image signal as a result of the performed test.

The method may further include transmitting the image signal to which the encoding processing is performed, to an external apparatus.

In accordance with further example aspect of the disclosure, a control method of an image processing apparatus including a signal processor configured to process an image signal having a plurality of color components is provided, the method including performing, by the signal processor, a color gamut conversion, a domain transform, a quantization processing and an encoding processing with respect to an input image signal, and in response to a high frequency component of the image signal exceeding a first critical level, controlling the signal processor to not perform the color gamut conversion. According to this, the image processing apparatus may efficiently compress the input image signal without distorting and/or reducing a distortion of a color thereof.

The method may further include, in response to differences between the color components of the image signal being less than a second critical level, performing the quantization processing without performing the color gamut conversion.

The method may further include, in response to the high frequency component of the image signal exceeding a third critical level lower than the first critical level and the differences between the color components of the image signal being less than a fourth critical level higher than the second critical level, performing the quantization processing without performing the color gamut conversion.

The method may further include, in response to the high frequency component of the image signal exceeding the first critical level, performing a test for the color gamut conversion, and determining whether to perform the color gamut conversion based on at least one of a compression ratio and a signal to noise ratio of the image signal as a result of the performed test.

The method may further include transmitting the image signal to which the encoding processing is performed, to an external apparatus.

As described above, according to various example embodiments, the image processing apparatus may selectively convert the color gamut of the image signal, thereby efficiently compressing the image signal without distorting and/or reducing a distortion of the color thereof.

### BRIEF DESCRIPTION OF THE DRAWINGS

The above and/or other aspects, features and attendant advantages of the present disclosure will become apparent and more readily appreciated from the following detailed description, taken in conjunction with the accompanying drawings, in which like reference numerals refer to like elements, and wherein:

FIG. 1 is a diagram illustrating an example of an image processing apparatus according to an example embodiment;

FIG. 2 is a block diagram illustrating an example configuration of an image processing apparatus according to an example embodiment;

FIG. 3 is a block diagram illustrating an example configuration of a signal processor according to an example embodiment;

FIG. 4 is a flowchart illustrating an example control process of an image processing apparatus for determining whether to convert a color gamut based on differences between color components according to an example embodiment;

FIG. 5 is a flowchart illustrating an example control process of an image processing apparatus for determining whether to convert the color gamut based on a frequency characteristic of an image signal according to another example embodiment;

FIG. 6 is a flowchart illustrating an example control process of an image processing apparatus for determining whether to convert the color gamut based on both the differences between color components and the frequency characteristic according to an example embodiment;

FIG. 7 is a flowchart illustrating an example control process of an image processing apparatus for determining whether to convert a color gamut based on both the differences between color components and the frequency characteristic according to further example embodiment;

FIG. 8 is a block diagram illustrating an example of a signal processor of an image processing apparatus for performing a color gamut conversion test according to an example embodiment;

FIG. 9 is a flowchart illustrating an example control process of an image processing apparatus for performing a color gamut conversion test according to an example embodiment;

FIG. 10 is a flowchart illustrating an example of a color gamut conversion test performed by an image processing apparatus according to an example embodiment;

FIG. 11 is a block diagram illustrating an example configuration of a signal processor according to an example embodiment;

FIG. 12 is a flowchart illustrating an example control process of an image processing apparatus according to an example embodiment;

FIG. 13 is a flowchart illustrating an example control process of an image processing apparatus according to an example embodiment; and

FIG. 14 is a diagram illustrating whether a color distortion phenomenon of image signal compressed in an image processing apparatus is improved based on whether an algorithm according to an example embodiment is applied.

### DETAILED DESCRIPTION

Below, various example embodiments will be described in greater detail with reference to accompanying drawings. The following descriptions of the example embodiments are made by referring to elements illustrated in the accompanying drawings, in which like numerals refer to like elements having substantively the same functions.

Hereinafter, in the description of the example embodiments, a ‘color gamut’, which represents bounds of colors displayable by a certain output device may also be referred to a color space. Types of the color gamut includes, for example, a RGB (red, green, blue) to represent colors in an additive color mixture method that if the colors are mixed, the brightness is increased, a CMYK (cyan, magenta, yellow, black) using a subtractive color mixture method, a HSV (hue, saturation, value), a CIELAB, a CIELUV, a YCoCg (Y: luminance, Co: orange chrominance, Cg: green chrominance), a YCbCr (Y: luminance, Cb: blue chrominance, Cr: red chrominance), etc. Components representing pixel values, such R, G and B in the RGB and C, M, Y and K in the CMYK, may be referred, for example, to as color components of an image signal.

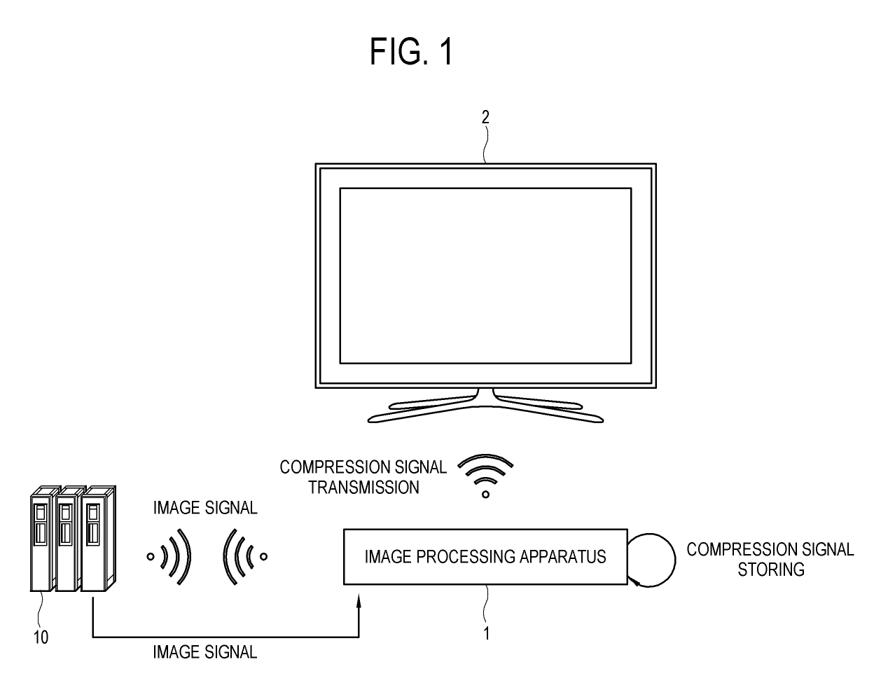

FIG. 1 is a diagram illustrating an example of an image processing apparatus according to an example embodiment. The image processing apparatus 1 according to an example embodiment may be achieved, for example, and without limitation, by a set-top box to receive an image signal and to compress the received signal into a digital signal, or a box or the like to transmit an image signal by wire or wireless to a display apparatus. As other example embodiments, the image processing apparatus 1 may be achieved by various apparatuses, such as, for example, and without limitation, a television (TV), a tablet personal computer (PC), a computer, a multimedia reproducing device, an electronic picture frame, a digital advertising board, a large format display (LFD), a signage, a wearable device, such as a smart watch and a head-mounted display, or the like, which receive an image signal, compress the received signal into a digital signal, and output the processed signal via a display. However, the disclosure is not limited thereto.

As illustrated in FIG. 1, the image processing apparatus 1 according to an example embodiment may receive an image signal from the outside. The image processing apparatus 1 may receive various signals, such as a satellite signal, a cable signal, a terrestrial signal and the like from a broadcasting transmission equipment 10, or receive image information from a camera, a camcorder and the like. At this time, since the received image signal has too much information, it should be compressed in a digital code in order to display, transmit or store a corresponding image. The image processing apparatus 1 may compress the input (received) image signal to store in a storage, to transmit by wire/wireless to an external display apparatus 2, or to output through a separate display using the compressed image signal.

The image processing apparatus 1 according to an example embodiment performs a color gamut conversion, a domain transform, a quantization processing and an encoding processing with respect to the input image signal, and compresses the input image signal by encoding the quantized signal in a digital code. Here, the image processing apparatus 1 may analyze the input image signal to determine whether when performing the compression after the color gamut conversion, the input image signal will be distorted in color and based on the determination result, and may not perform the color gamut conversion, but the quantization processing and the encoding processing. In other words, the image processing apparatus 1 may perform quantization processing and encoding processing without performing color gamut conversion. As an example, if differences between color components in a specific pixel or region is less than a critical level, the image processing apparatus 1 determines that the image signal may be distorted in color and does not perform the color gamut conversion, but the domain transform, the quantization processing and the encoding processing. In other words, to compare the differences between the color components in a RGB color gamut, the image processing apparatus 1 may compare a difference between an R value and a B value, a difference between a B value and a G value and a difference between an R value and a G value, which are color components in the specific pixel or region. As another example, if a frequency component of the image signal exceeds a critical level, the image processing apparatus 1 may not perform the color gamut conversion, but the quantization processing and the encoding processing. With this, the image processing apparatus may efficiently compress the image signal without distorting and/or reducing a distortion of the color thereof.

Hereinafter, an example configuration of the image processing apparatus 1 will be described with reference to a block diagram of the image processing apparatus.

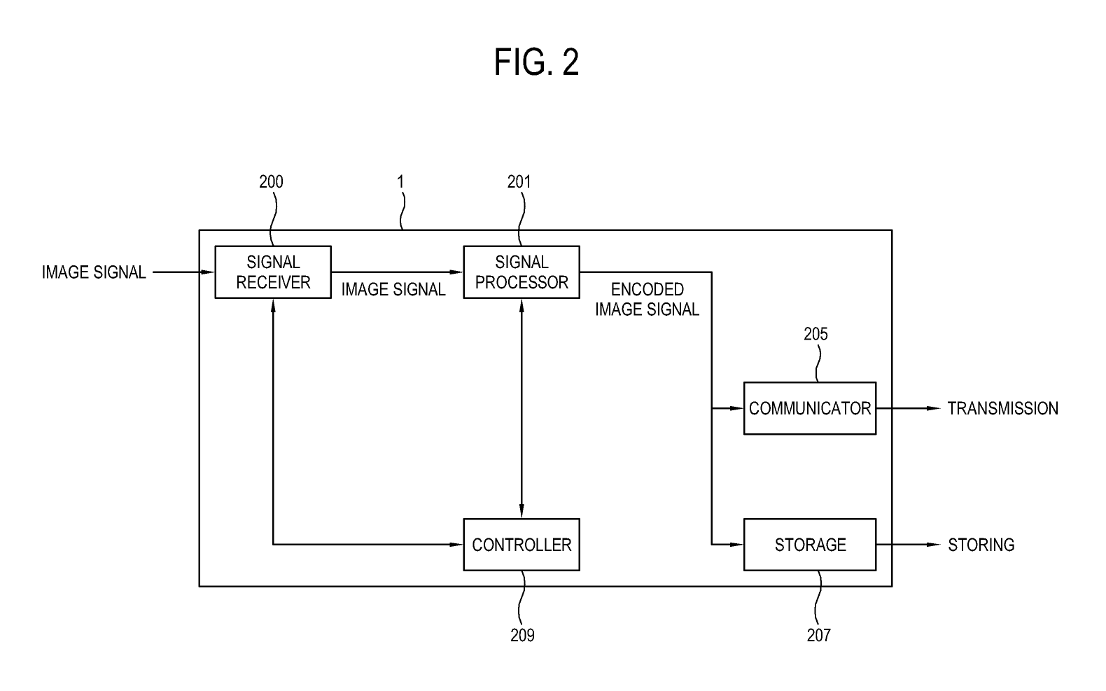

FIG. 2 is a block diagram illustrating an example configuration of the image processing apparatus according to an example embodiment. The image processing apparatus 1 according to an example embodiment includes a signal processor 201 and a controller (e.g., including processing circuitry) 209. The image processing apparatus 1 according to an example embodiment may further include at least one of a signal receiver (e.g., including receiving circuitry) 200, a display (not shown), a communicator (e.g., including communication circuitry) 205, and a storage 207. The configuration of the image processing apparatus 1 according to an example embodiment, as illustrated in FIG. 2, is merely an example, and the image processing apparatus 1 according to an example embodiment may be also achieved by configurations other than that as illustrated in FIG. 2. Also, respective elements of the image processing apparatus may, without limitation, be achieved by devices, software modules, circuits or chips for performing functions explained with reference thereto.

The image processing apparatus 1 may include a signal receiver 200 including various circuitry for receiving the image signal. The signal receiver 200 may be provided with, for example, and without limitation, a tuner. The tuner receives tuning a broadcasting signal of any one selected by a user from among a plurality of channels. The signal receiver 200 may also receive an image signal from a server via an electronic device, such as a digital versatile disk (DVD), a PC or the like, a mobile device such as a smart phone, or an internet.

The signal processor 201 may include various signal processing circuitry and performs an image processing with respect to the image signal received via the signal receiver 200, and displays an image on a display based on the processed image signal, transmits the processed image signal to an external apparatus 2 via the communicator 205, or stores the processed image signal in the storage 207. Image processing processes performed by the circuitry of the signal processor 201 may include, for example, demultiplexing for separating a transmission stream including the image signal into sub-streams, such as an image signal, an audio signal, and addition data, de-interlacing for converting the image signal from an interlace form to a progressive form, scaling for adjusting the resolution of the image signal, noise reduction for improving image quality, detail enhancement, frame refresh rate conversion, etc. The signal processor 201 may perform a compression processing with respect to the received image signal to output an encoded digital image signal. The image compression may be performed by block units, dividing an image into a plurality of macroblocks. The macroblocks may have various sizes, for example, 16*16, 32*32, 64*64, etc. The sizes of the macroblocks are adaptively selected for compression efficiency.

The image processing apparatus 1 may further include a display (not shown) for outputting an image based on the image signal processed by the signal processor 201. Achieved types of the display are not limited. For instance, the display may be achieved in various display types, such as a liquid crystal display (LCD) , a plasma display panel (PDP), a light-emitting diode (LED) display, an organic light emitting diodes (OLED) display, a surface-conduction electron-emitter, a carbon nano-tube, a nano-crystal display, or the like, but is not limited thereto.

If the display is a LCD type, the display includes a LCD panel, a backlight unit to supply light to the LCD panel, a panel driving board to drive the LCD panel, etc. The display may be also achieved by an OLED panel, which is a spontaneous emission element, without the backlight unit.

The image processing apparatus 1 may further include a communicator 205 which may include various communication circuitry for transmitting the compressed image signal to the outside. The communicator 205 is configured to communicate with the external apparatus 2. The communicator 205 is achieved in various types according to achieved types of the external apparatus or the image processing apparatus 1. For instance, the communicator 205 may include a connecting part for wired communication. The connecting part may transmit/receive signals/data based on standards, such as a high definition multimedia interface (HDMI), a HDMI-consumer electronics control (CEC), a universal serial bus (USB), a component and so on, and include more than at least one connector or terminal corresponding to the standards, respectively. The communicator 205 may communicate by wire with a plurality of servers via a wired local area network (LAN).

According to design methods of the image processing apparatus 1, the communicator 205 may include various configurations besides the connecting part including the connector or terminals for wired connection. As a non-limiting example, the communicator 205 may include a radio frequency (RF) circuit for transmitting and receiving a RF signal to perform a wireless communication with the external apparatus, and may be configured to perform communication via at least one from among wireless fidelity (Wi-Fi), Bluetooth, Zigbee, ultra-wide band (UWB), wireless USB, and near field communication (NFC).

The image processing apparatus 1 may further include storage 207 for storing the compressed image signal. The storage 207 includes a non-volatile memory (writable ROM), which retains data regardless of whether the image processing apparatus 1 is turned on or off and which is writable to reflect changes. In other words, the storage 207 may be provided with any one of a flash memory, an EPROM and an EEPROM. The storage 207 may be further provided with a volatile memory, such as a DRAM or a SRAM, which has a reading or writing speed faster than the non-volatile memory.

The controller 209 performs controls needed for operating all the elements of the image processing apparatus 1. The controller 209 may include a control program for controlling to perform the control operation as described above, a non-volatile memory in which the control program is installed, a volatile memory in which at least a portion of the installed control program is loaded, and at least one microprocessor or central processing unit (CPU) for executing the loaded control program.

The controller 209 may analyze differences between the color components, frequency characteristic and the like of the image signal, and perform a color conversion test to determine whether to execute the color gamut conversion. The controller 209 may control the signal processor 201 to selectively perform the color gamut conversion with respect to the received image signal based on the determination, and then to perform the quantization processing and the encoding processing.

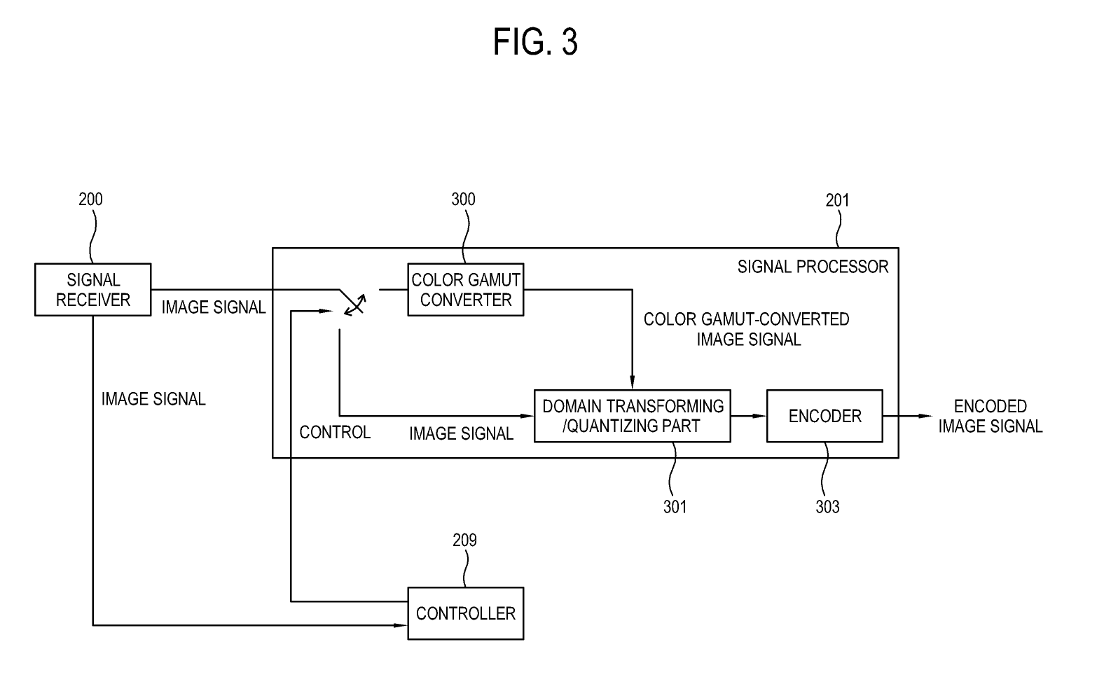

Hereinafter, a more detailed configuration of the signal processor 201 for performing the compression processing with respect to the image signal will be described with reference to FIG. 3. Referring to FIG. 3, the signal processor 201 may include a color gamut converter (e.g., including converting circuitry and/or program elements) 300, a domain transforming/quantizing part (e.g., including transforming/quantizing circuitry and/or program elements) 301 and an encoder 303.

The color gamut converter 300 may include various circuitry and/or program elements and converts color components of a received image signal to another color gamut. Although the HEVC as described above converts the input image signal of RGB color gamut into an image signal of YCoCg color gamut, which has a high compression ratio and which is inversely convertible without loss, and compresses the converted image signal, the idea of the disclosure is not limited thereto.

According to an example embodiment, the color gamut conversion may be selectively performed. The controller 209 may analyze the input image signal to determine whether to perform the color gamut conversion with respect to the image signal. For eyes of the human, the smaller the differences between the color components are and the higher the high frequency component is, the more a sensitivity capable of perceiving details of pixels is decreased and the easier a color distortion is perceived, thereby generating degradation with high subjective sensitivity. Accordingly, the analysis of the image signal include determining whether the respective differences between the color components of image signal are less than a critical level and/or the high frequency component of the image signal exceeds a critical level. The controller 209 may also determine whether to perform the color gamut conversion according to whether a loss does not occur in a compression ratio or a signal to noise ratio as a result of color gamut conversion test, i.e., based on a rate-distortion cost varying according to the color gamut conversion.

The controller 209 may control the signal processor 201 not to perform the color gamut conversion, based on the determination on whether to perform the color gamut conversion. As an example, as illustrated in FIG. 3, the signal processor 201 includes a switch therein, so that under the control of the controller 209, the image signal selectively bypasses the color gamut converter 300 and enters the domain transforming/quantizing part 301. The disclosure is not limited to the construction of the signal processor 201 including the switch. The controller 209 may control the signal processor 201, so that the image signal passes through the color gamut converter 300, but the color gamut converter 300 does not selectively perform the color gamut conversion with respect to the image signal based on the analysis result of the image signal.

The image signal of which the color gamut is changed or not enters the domain transforming/quantizing part 301. The domain transforming/quantizing part 301 performs a domain transform and a quantization processing with respect to the image signal. The domain transform, which transforms the image signal of time domain into an image signal of frequency domain, may be performed for example, and without limitation, by any one of a discrete cosine transform (hereinafter, also referred to a ‘DCT transform’), a fast fourier transform (hereinafter, also referred to a ‘FFT transform’), and a karhunen loeve transform (hereinafter, also referred to a ‘KLV transform’), but is not limited thereto. The encoder 303 encodes the quantized image signal to convert into a digital image signal. The image signal is converted into the encoded image signal at the signal processer 201 and transmitted to the display, the communicator 205 and the storage 207.

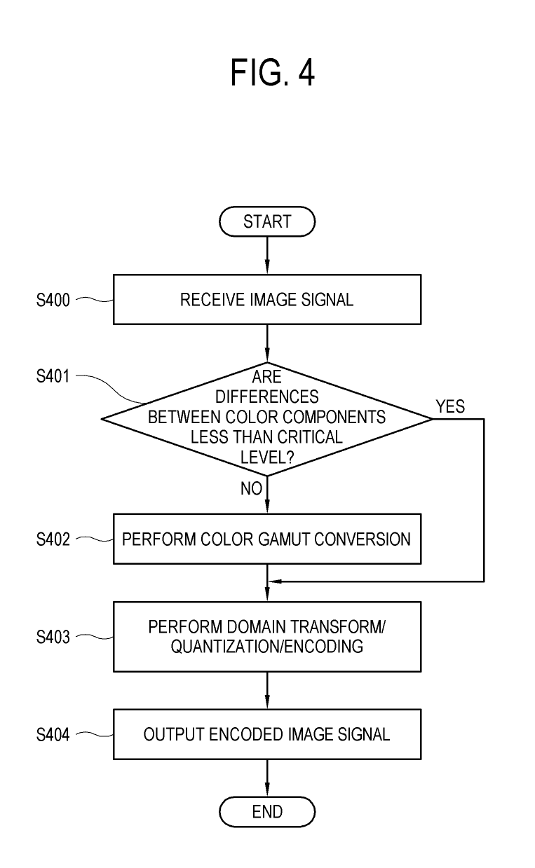

FIG. 4 is a flowchart illustrating an example control process of the image processing apparatus for determining whether to convert the color gamut based on the differences between the color components according to an example embodiment. At an operation S400, the signal processor 201 receives an image signal. At an operation S401, the controller 209 determines whether differences between color components of the image signal are less than a critical level. The controller 209 determines whether to omit performing a color gamut conversion, and omits performing a color gamut conversion if the differences between the color components are less than the critical level, and to perform the color gamut conversion if the differences between the color components exceed the critical level. If it is determined to perform the color gamut conversion, at an operation S402, the signal processor 201 performs the color gamut conversion with respect to the image signal. At an operation S403, the signal processor 201 performs a domain transform, a quantization processing and an encoding processing with respect to the image signal to which the color gamut conversion is performed or not. At an operation S404, the signal processor 201 outputs the encoded image signal.

The execution of the color gamut conversion may be determined by macroblock units. If all of differences between color components of each pixel included in every macroblock is less than the critical level, the controller 209 may determine to omit the color gamut conversion. However, the disclosure is not limited thereto.

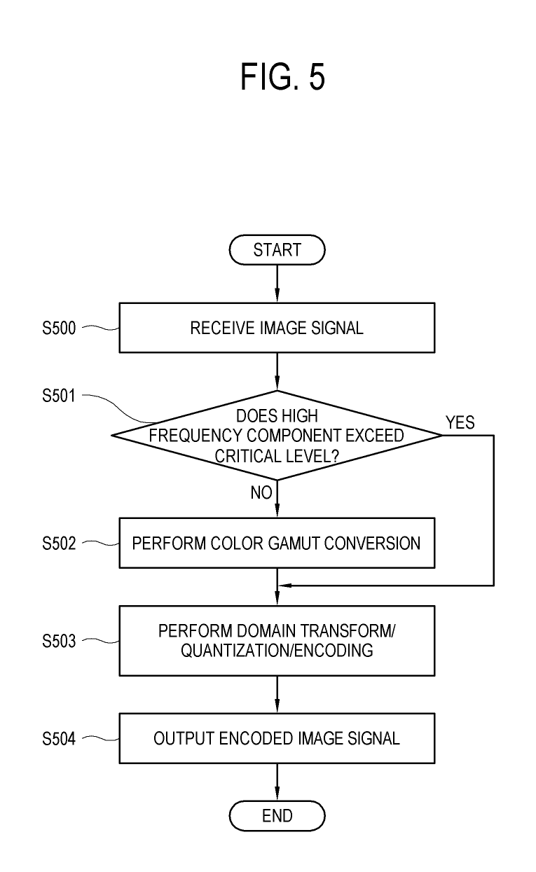

FIG. 5 is a flowchart illustrating an example control process of the image for processing apparatus determining whether to convert the color gamut based on a frequency characteristic of the image signal according to another example embodiment.

At an operation S500, the signal processor 201 receives an image signal. At an operation S501, the controller 209 determines whether a high frequency component of the image signal exceeds a critical level. The controller 209 determines to omit performing a color gamut conversion if the high frequency component of the image signal exceeds the critical level, and to perform the color gamut conversion if the high frequency component of the image signal is less than the critical level. If it is determined to perform the color gamut conversion, at an operation S502, the signal processor 201 performs the color gamut conversion with respect to the image signal. At an operation S503, the signal processor 201 performs a domain transform, a quantization processing and an encoding processing with respect to the image signal to which the color gamut conversion is performed or not. Lastly, at an operation S504, the signal processor 201 outputs the encoded image signal.

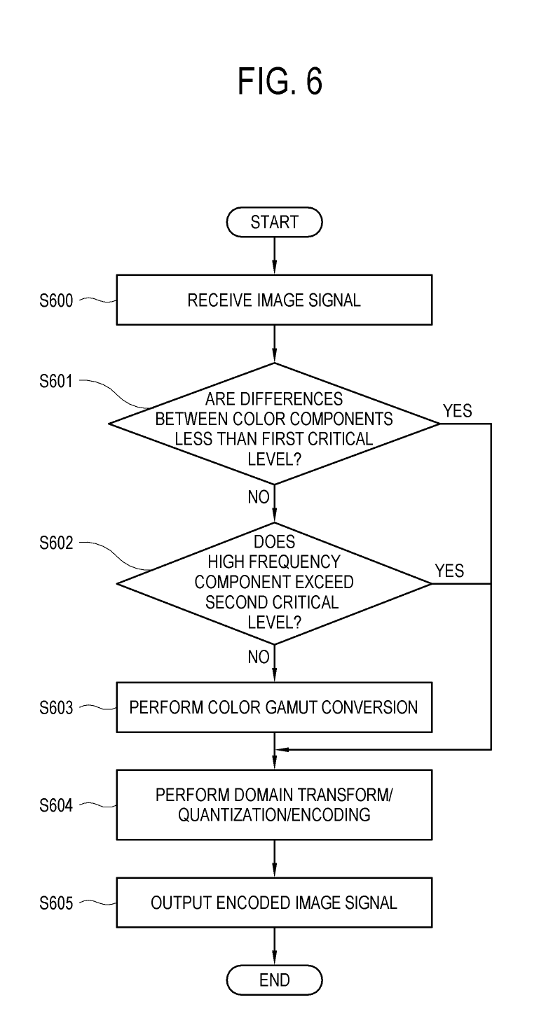

FIG. 6 is a flowchart illustrating an example control process of the image processing apparatus for determining whether to convert the color gamut based on both the differences between color components and the frequency characteristic according to an example embodiment.

At an operation S600, the signal processor 201 receives an image signal. At an operation S601, the controller 209 determines whether differences between color components of the image signal are less than a first critical level. If the differences between the color components are less than the first critical level, the controller 209 determines to omit performing a color gamut conversion. If the differences between the color components exceed the first critical level, at an operation S602, the controller 209 determines whether a high frequency component of the image signal exceeds a second critical level. The controller 209 determines to omit performing the color gamut conversion if the high frequency component of the image signal exceeds the second critical level, and to perform the color gamut conversion if the high frequency component of the image signal is less than the second critical level. If it is determined to perform the color gamut conversion, at an operation S603, the signal processor 201 performs the color gamut conversion with respect to the image signal. At an operation S604, the signal processor 201 performs a domain transform, a quantization processing and an encoding processing with respect to the image signal to which the color gamut conversion is performed or not. At an operation S605, the signal processor 201 outputs the encoded image signal.

In the example embodiment, the image processing apparatus 1 more specifically determines whether the color is distorted taking into account both the differences between the color components and the frequency characteristic of the image signal, and compresses the image signal. As another example, the controller 209 may determine whether the color is distorted synthetically taking account of the differences between the color components and the frequency characteristic of the image signal. For instance, the controller 209 may calculate (determine) a synthetic color-distortion cost by multiplying the differences between the color components and a ratio of the high frequency component by predetermined coefficients, respectively and adding them, and then determine whether the color will be distorted based the calculated synthetic color-distortion cost.

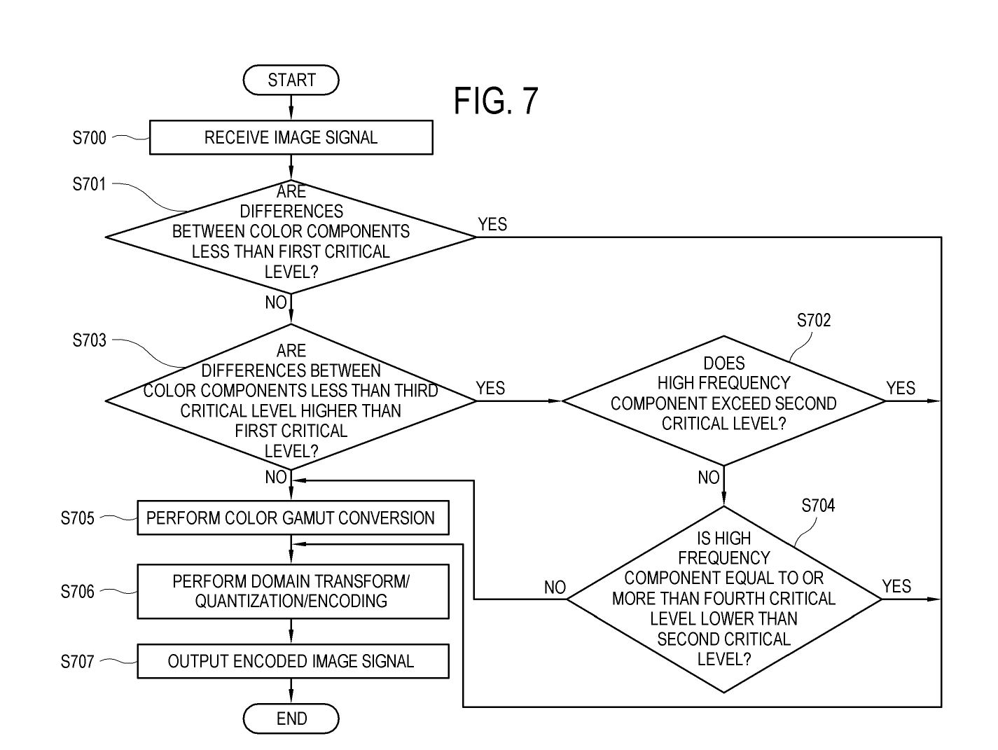

FIG. 7 is a flowchart illustrating an example control process of the image processing apparatus for determining whether to convert the color gamut based on both the differences between color components and the frequency characteristic according to further example embodiment.

At an operation S700, the signal processor 201 receives an image signal. At an operation S701, the controller 209 determines whether differences between color components of the image signal are less than a first critical level. If the differences between the color components are less than the first critical level, the controller 209 determines to omit performing a color gamut conversion for the image signal. If the differences between the color components exceeds the first critical level, at an operation S703, the controller 209 determines whether the differences between the color components are less than a third critical level higher than the first critical level. If the differences between the color components exceed the third critical level, the controller 209 determines to perform the color gamut conversion. If the differences between the color components are less than the third critical level, as an operation S702, the controller 209 determines whether a high frequency component of the image signal exceeds a second critical level. If the high frequency component of the image signal exceeds the second critical level, the controller 209 determines to omit performing the color gamut conversion for the image signal. If the high frequency component of the image signal is less than the second critical level, at an operation S704, the controller 209 determines whether the high frequency component of the image signal exceeds a fourth critical level lower than the second critical level. If the high frequency component of the image signal exceeds the fourth critical level, the controller 209 determines to omit performing the color gamut conversion for the image signal. If the high frequency component of the image signal is less than the fourth critical level, the controller 209 determines to perform the color gamut conversion for the image signal.

If it is determined to perform the color gamut conversion for the image signal, at an operation S705, the signal processor 201 performs the color gamut conversion with respect to the image signal. At an operation S706, the signal processor 201 performs a domain transform, a quantization processing and an encoding processing with respect to the image signal to which the color gamut conversion is performed or not. At an operation S707, the signal processor 201 outputs the encoded image signal.

In the example embodiment, the image processing apparatus 1 may determine that the distortion of the color can occur if the differences between the color components of the image signal are higher than the first critical level, but less than the third critical level and the high frequency component of the image signal is equal to or more than the fourth critical level lower than the second critical level. In other words, the image processing apparatus 1 determines whether to perform the color gamut conversion synthetically taking account of the differences between the color components and the frequency characteristic of the image signal.

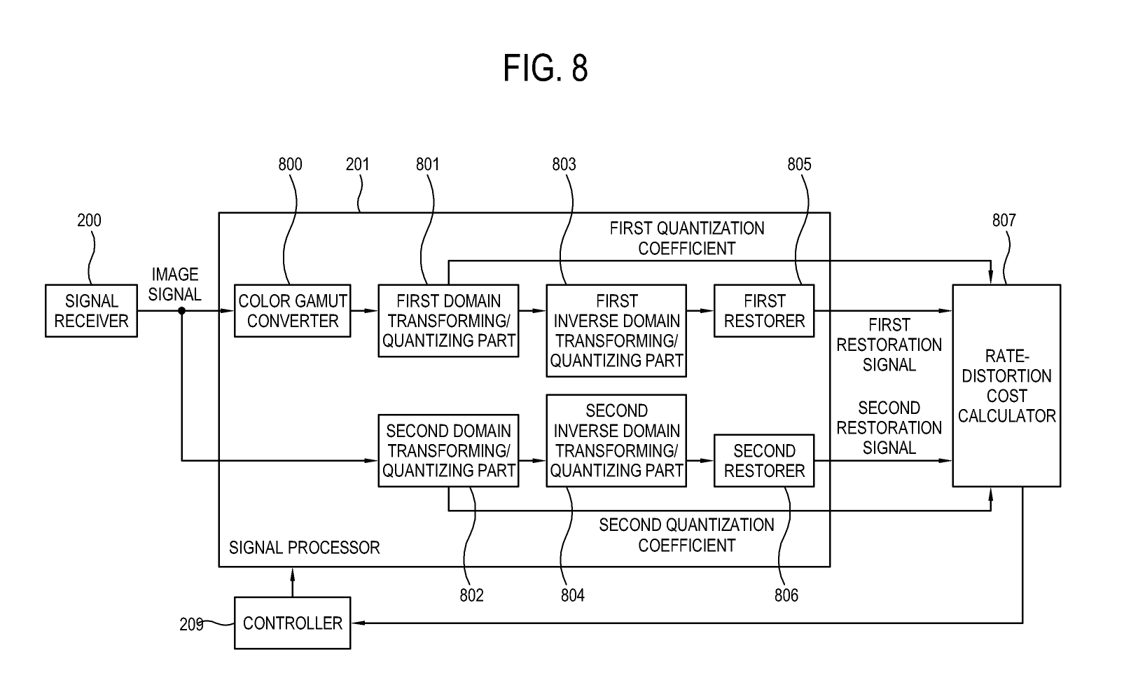

FIG. 8 is a block diagram illustrating an example configuration of the image processor according to an example embodiment. The image processor 201 may include a color gamut converter (e.g., including circuitry and/or program elements) 800, first and second domain transforming/quantizing parts (e.g., each including circuitry and/or program elements) 801 and 802, first and second inverse domain transforming/quantizing parts (e.g., each including circuitry and/or program elements) 803 and 804, first and second restorers (e.g., each including circuitry and/or program elements) 805 and 806, and a rate-distortion cost calculator (e.g., including circuitry and/or program elements) 807. In FIG. 8, the image processor 201 is illustrated as an example of an image processor for performing a color gamut conversion test. Accordingly, the image processor 201 is not limited to the configuration illustrated in FIG. 8.

If an image signal is received by the signal processor 201, it enters the color gamut converter 800 and the second domain transforming/quantizing part 802. The color gamut converter 800 performs the color gamut conversion with respect to the image signal and transmits a first image signal to which the color gamut conversion is performed, to the first domain transforming/quantizing part 801. The first domain transforming/quantizing part 801 performs a domain transform from a time domain to a frequency domain with respect to the first image signal, and performs a quantization processing with respect to the domain transformed-first image signal to generate a first quantization coefficient. The second domain transforming/quantizing part 802 performs the domain transform from the time domain to the frequency domain with respect to a second image signal to which the color gamut conversion is not performed, and performs the quantization processing with respect to the domain transformed-second image signal to generate a second quantization coefficient. The first and second domain transforming/quantizing parts 801 and 802 transmit the generated first and second quantization coefficients to the rate-distortion cost calculator 807. The first and second inverse domain transforming/quantizing parts 803 and 804 perform an inverse domain transform from the frequency domain to the time domain and an inverse quantization processing with respect to the first and second image signal to which the domain transform and the quantization processing are performed. The first and second restorers 805 and 806 perform a restoration processing with respect to the inversely quantized first and second image signals of time domain. The first and second restorers 805 and 806 transmit the restored first and second restoration signals to the rate-distortion cost calculator 807. The rate-distortion cost calculator 807 calculates (determines) a rate-distortion cost using the generated first and second quantization coefficients and the first and second restoration signals.

The rate-distortion cost, which may be calculated using a compression ratio and a mean square error (MSE), may, for example, and without limitation, be expressed by the following mathematical formula.

J=D+λR [Mathematical formula 1]

Here, J is a rate-distortion cost, D is a mean square error (hereinafter, also referred to MSE) of an image calculated from the first and second restoration signals, R is a bit rate of a compression signal calculated from the first and second quantization coefficients and λ as a coefficient for calculating the rate-distortion cost is a separately calculated lagrange multiplier. The mathematical formula 1 is merely an example for calculating the rate-distortion cost and the disclosure is not limited thereto.

In the example embodiment, the controller 209 performs a color gamut conversion test with respect to the image signal to determine whether when the color gamut conversion is performed with respect to the image signal, a loss occurs in the compression ratio and the signal to noise ratio, as compared with when the color gamut conversion is not performed, and determines whether to perform the color gamut conversion with respect to the image signal, using the rate-distortion cost calculated based on the color gamut conversion test.

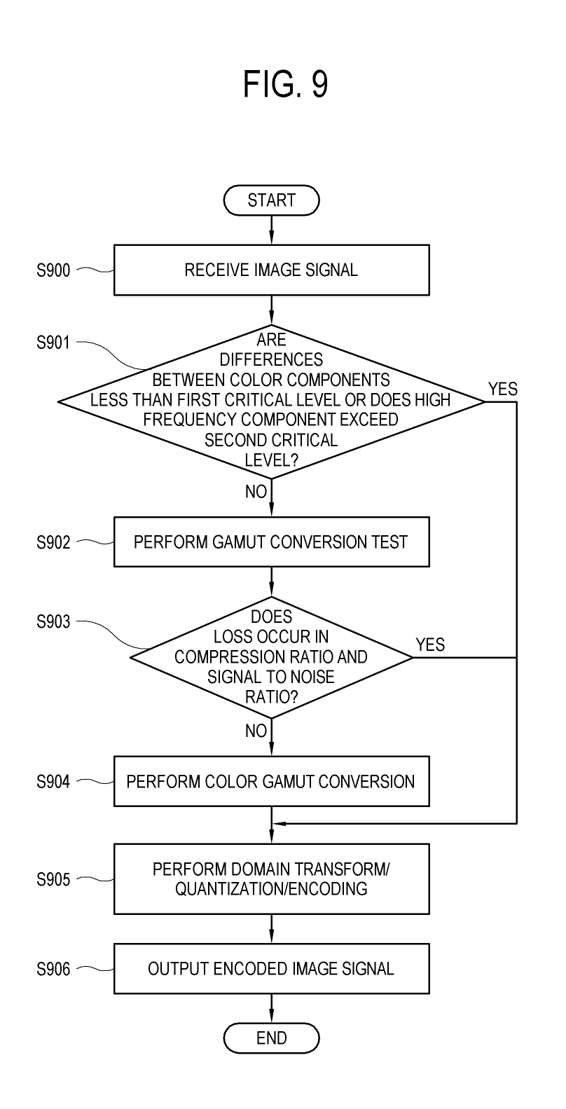

FIG. 9 is a flowchart illustrating an example control process of an image processing apparatus for performing the color gamut conversion test according to an example embodiment. At an operation S900, the signal processor 201 receives an image signal. At an operation S901, the controller 209 determines whether a color distortion will occur based on whether differences between color components of the image signal are less than a first critical level or a high frequency component of the image signal exceeds a second critical level. For this, the controller 209 may perform the determination according to the operations as described above with reference to FIGS. 4 to 7. If it is determined that the color distortion will occur, the controller 209 determines to omit performing a color gamut conversion. If it is determined that the color distortion will not occur, at an operation S902, the controller 209 performs a color gamut conversion test. At an operation S903, as a result of the color gamut conversion test, if it is determined to perform the color gamut conversion, the controller 209 determines whether a loss occurs in a compression ratio and a signal to noise ratio of the image signal. As a result of the determination, if it is determined that the loss occurs, the controller 209 determines to omit performing the color gamut conversion. If it is determined that the loss does not occur, the controller 209 determines to perform the color gamut conversion. If it is determined to perform the color gamut conversion, at an operation S904, the signal processor 201 performs the color gamut conversion with respect to the image signal. At an operation S905, the signal processor 201 performs a domain transform, a quantization processing, and an encoding processing with respect to the image signal to which the color gamut conversion is performed or not. Lastly, at an operation S906, the signal processor 201 outputs the encoded image signal.

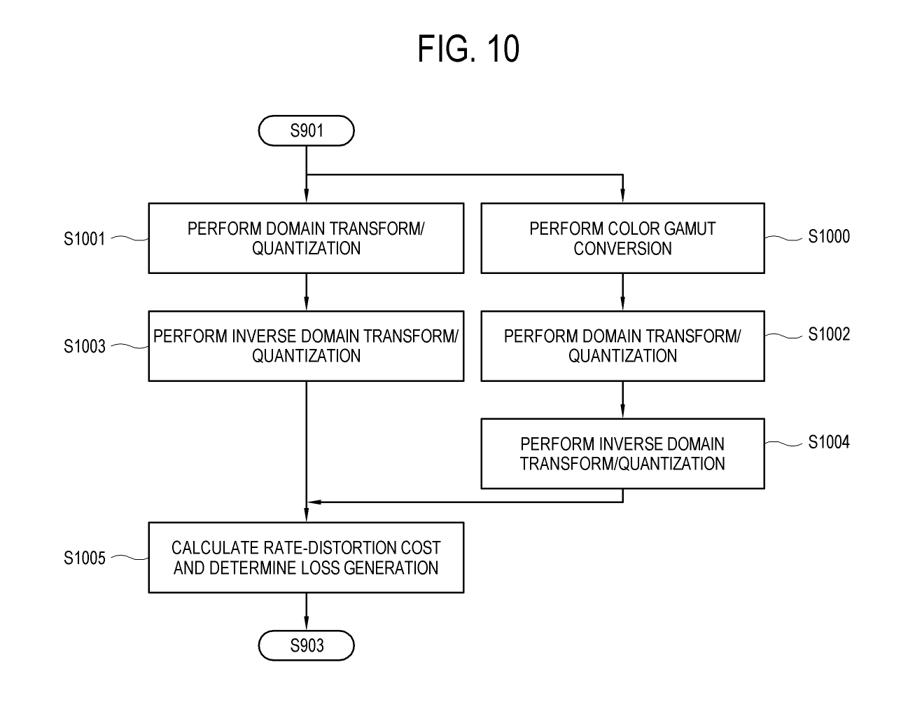

FIG. 10 is a flowchart illustrating an example of the color gamut conversion test of FIG. 9. At the operation S901, if the differences between the color components of the image signal exceeds the first critical level or the high frequency component of the image signal is less than the second critical level, the controller 209 determines that the color distortion does not occur, and performs the color gamut conversion test (S902 in FIG. 9). For the color gamut conversion test, at an operation S1000, the controller 209 first controls the signal processor 201 to perform the color gamut conversion with respect to the image signal. At an operation S1002, the signal processor 201 performs a domain transform from a time domain to a frequency domain with respect to a first image signal to which the color gamut conversion is performed, performs a quantization processing with respect to the first image signal transformed into the frequency domain to generate a first quantization coefficient, and at an operation S1004, performs an inverse domain transform from the frequency domain to the time domain and an inverse quantization processing with respect to the quantized first image signal. The signal processor 201 may generate a first restoration signal from the first image signal inversely quantized and inversely transformed into the time domain. And, at an operation S1001, the signal processor 201 performs a domain transform from the time domain to the frequency domain with respect to a second image signal to which the color gamut conversion is not performed, performs a quantization processing with respect to the second image signal transformed into the frequency domain to generate a second quantization coefficient, and at an operation S1003, performs an inverse domain transform from the frequency domain to the time domain and an inverse quantization processing with respect to the quantized second image signal. The signal processor 201 may generate a second restoration signal from the second image signal inversely quantized and inversely transformed into the time domain. The controller 209 calculates a rate-distortion cost using the first and second quantization coefficients and the first and second restoration signals, to determine whether a loss occurs in a compression ratio and a signal to noise ratio during the color gamut conversion.

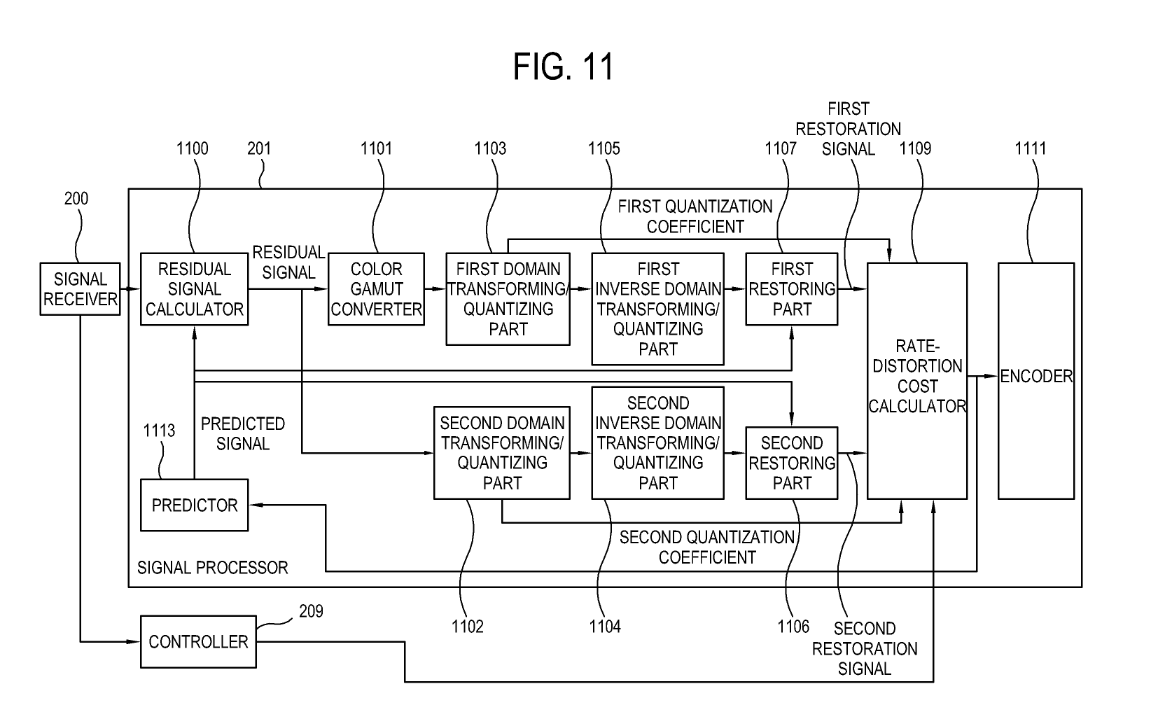

FIG. 11 is a block diagram illustrating an example configuration of the signal processor according to an example embodiment. The signal processor 201, which compresses an image signal by the HEVC, determines whether to perform the color gamut conversion using a residual signal as a difference between a predicted signal and the image signal, and preforms the compression. For this, the signal processor 201 may further include a predictor (e.g., including circuitry and/or program elements) 1113 to generate the predicted signal and a residual signal calculator (e.g., including circuitry and/or program elements) 1100 to generate the residual signal by comparing the predicted signal and the image signal. A color gamut converter 1101 performs a color gamut conversion with respect to the residual signal. First and second domain transforming and quantizing parts 1103 and 1102 perform a domain transform from the time domain to the frequency domain with respect to a first residual signal to which the color gamut conversion for the time domain is performed and a second residual signal to which the color gamut conversion for the time domain is not performed, and perform a quantization processing with respect to the first and second residual signals transformed into the frequency domain, to generate first and second quantization coefficients, respectively. First and second inverse domain transforming and quantizing parts 1105 and 1104 perform an inverse domain transform from the frequency domain to the time domain with respect to the quantized first and second residual signals and perform an inverse quantization processing with respect to the first and second residual signals transformed into the time domain. First and second restorers 1107 and 1106 generate first and second restoration signals, which are restored image signals, using the inversely quantized first and second residual signals and the predicted signal generated by the predictor 1113. A rate-distortion cost calculator 1109 calculates a rate-distortion cost based on the first and second quantization coefficients and the first and second restoration signals.

The controller 209 determines whether the color distortion will occur in the image signal and whether to perform the color gamut conversion based on the rate-distortion cost. For instance, the controller 209 determines whether the color distortion will occurs according to whether the differences between the color components of the image signal are less than the first critical level or the high frequency component of the image signal exceeds a second critical level. If it is determined that the color distortion will not occur, the controller 209 performs the color gamut conversion test to determine whether to perform the color gamut conversion. An encoder 1111 encodes and outputs the first residual signal or the second residual signal to which the domain transform and the quantization processing are performed, according to the determination of the controller 209 with respect to whether to perform the color gamut conversion.

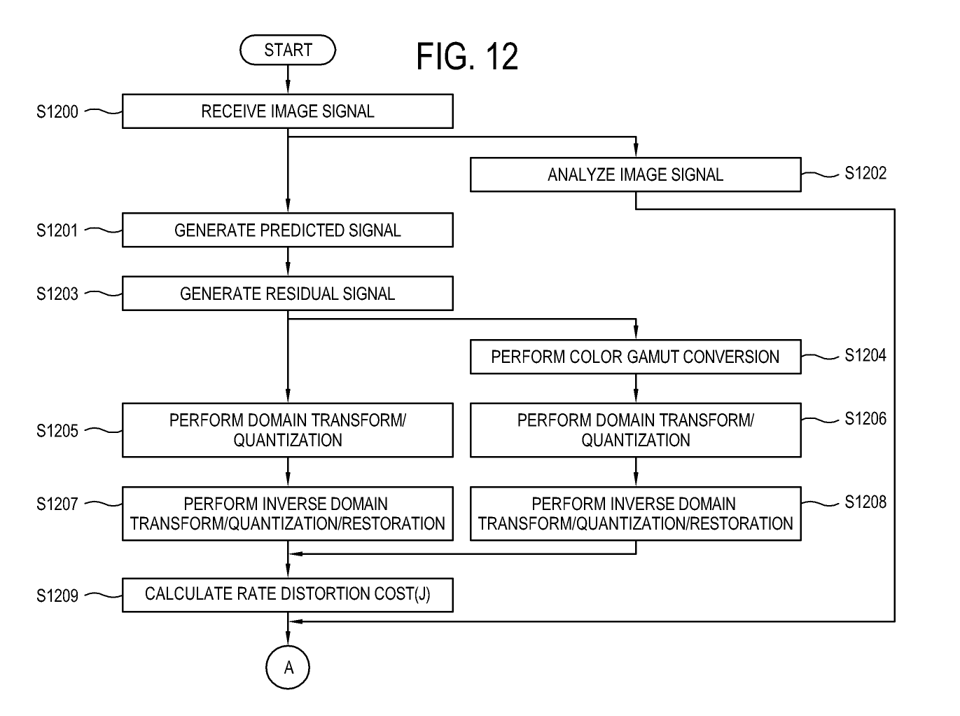

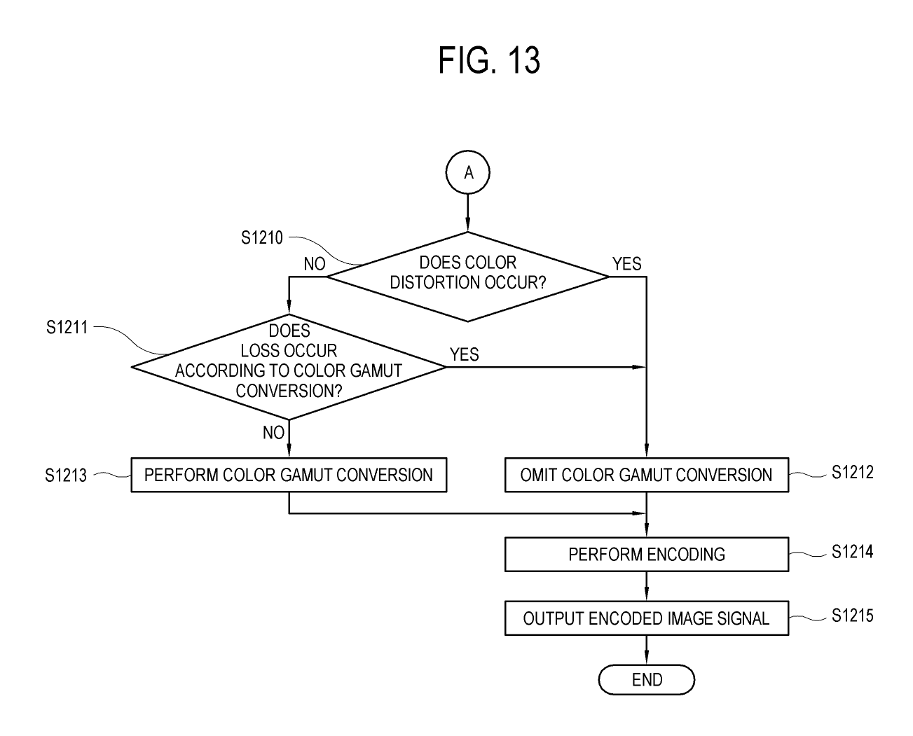

FIGS. 12 and 13 are flowcharts illustrating example control processes of the image processing apparatus according to an example embodiment. At an operation S1200, the signal processor 201 receives an image signal. At an operation S1201, the predictor 1113 generates a predicted signal. At an operation S1202, the controller 209 determines to analyze the image signal. The analysis of the image signal may be carried out according to the method as described above with reference to FIGS. 4 to 7. At an operation S1203, the residual calculator 1110 may calculate a residual, which is a difference between the image signal and the predicted signal, to generate a residual signal. At an operation S1204, the color gamut converter 1101 performs a color gamut conversion with respect to the residual signal. At an operation S1206, the first domain transforming/quantizing part 1103 transforms a first residual signal to which the color gamut conversion is performed, from a time domain to a frequency domain, and quantizes the first residual signal transformed to the frequency domain to generate a first quantization coefficient. At an operation S1208, the first inverse domain transforming/quantizing part 1105 inversely transforms the quantized first residual signal from the frequency domain to the time domain and inversely quantizes the first residual signal transformed to the time domain, and the first restorer 1107 generates a first restoration signal using the predicted signal. At an operation S1205, the second domain transforming/quantizing part 1102 transforms a second residual signal to which the color gamut conversion is not performed, from the time domain to the frequency domain, and quantizes the second residual signal transformed to the frequency domain to generate a second quantization coefficient. At an operation S1207, the second inverse domain transforming/quantizing part 1106 inversely transforms the quantized second residual signal from the frequency domain to the time domain and inversely quantizes the second residual signal transformed to the time domain, and the second restorer 1106 generates a second restoration signal using the predicted signal. At an operation S1209, the rate-distortion cost calculator 1109 calculates a rate-distortion cost using the first and second quantization coefficients and the first and second restoration signals. At an operation S1210, the controller 209 determines whether a color distortion will occur based on the analysis of the image signal performed at the operation S1202. If it is determined that the color distortion will occur, at an operation S1212, the controller 209 determines to omit the color gamut conversion. If it is determined that the color distortion will not occur, at an operation S1211, the controller 209 determines whether a loss will occur according to the color gamut conversion, using the rate-distortion cost calculated at the operation S1209. If it is determined that the loss will occur according to the color gamut conversion, at an operation S1212, the controller 209 determines to omit the color gamut conversion. If it is determined that the loss will not occur according to the color gamut conversion, the controller 209 controls the signal processor 201 to perform the color gamut conversion. At an operation S1214, the signal processor 201 encodes the first residual signal or the second residual signal to which the domain transform and the quantization processing are performed, based on the determination on whether to perform the color gamut conversion, and at an operation S1215, outputs the encoded image signal.

As an additional example embodiment, as a result of the color gamut conversion test, if it is determined that the signal to noise ratio exceeds a predetermined critical level when the color gamut conversion is performed, the controller 209 may omit performing the color gamut conversion without the need to calculate the rate-distortion cost.

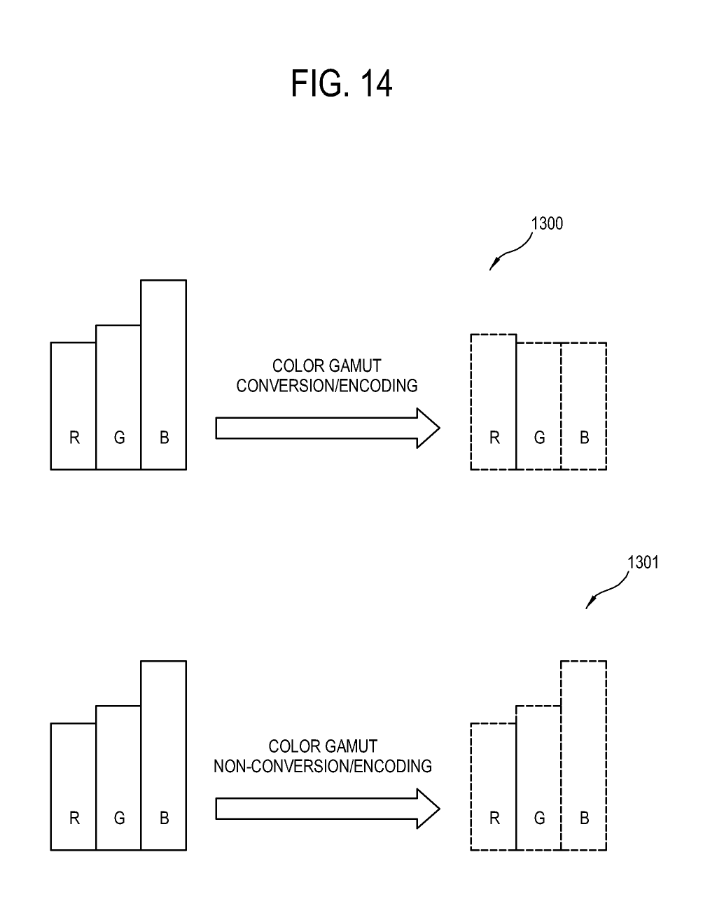

FIG. 14 is a diagram illustrating an example of whether a color distortion phenomenon of image signal compressed in the image processing apparatus is improved according to whether an algorithm according to an example embodiment is applied. The controller 209 analyzes the image signal to determine whether the color distortion will occur. To be more specific, when performing the color gamut conversion with respect to the image signal and compressing the image signal, if it is determined that the color distortion will occur by the analysis of the image signal, the controller 209 determines to omit the color gamut conversion even though the color gamut conversion represents higher efficiency in the rate-distortion cost. The determination on whether the color distortion will occur may be carried out through the method as described above with reference to FIGS. 4 to 7. A reference numeral 1300 shows a color distortion phenomenon of pixels when performing the color gamut conversion and then the encoding processing, and a reference numeral 1301 shows that the color distortion phenomenon of pixels is improved when omitting the color gamut conversion and performing the encoding processing.

While various example embodiments have been illustrated and described with reference to various example embodiments thereof, it will be understood by those skilled in the art that various changes in form and details may be made therein without departing from the spirit and scope of the present disclosure as defined by the appended claims and their equivalents.

What is claimed is:

1. An image processing apparatus comprising:
a signal processor configured to process an image signal comprising a plurality of color components; and
a controller configured to control the signal processor:
to perform a color gamut conversion, a domain transform, a quantization processing and an encoding processing with respect to an input image signal, and
in response to differences between the color components of the image signal being less than a first critical level, to not perform the color gamut conversion.

2. The apparatus according to claim 1, wherein the controller is configured to, in response to a high frequency component of the image signal exceeding a second critical level,
control the signal processor to not perform the color gamut conversion, and to perform the quantization processing without performing the color gamut conversion.

3. The apparatus according to claim 2, wherein the controller is configured to, in response to the differences between the color components of the image signal being less than a third critical level higher than the first critical level and the high frequency component of the image signal exceeding a fourth critical level lower than the second critical level,
control the signal processor to not perform the color gamut conversion, and to perform the quantization processing without performing the color gamut conversion.

4. The apparatus according to claim 1, wherein the controller is configured to control the signal processor, in response to the differences between the color components of the image signal exceeding the first critical level,
to perform a test for the color gamut conversion, and
to determine whether to perform the color gamut conversion based on at least one of: a compression ratio and a signal to noise ratio of the image signal as a result of the performed test.

5. The apparatus according to claim 1, further comprising:
a communicator comprising communication circuitry configured to communicate with an external apparatus,
wherein the controller is configured to control the communicator to transmit the image signal to which the encoding processing is performed, to the external apparatus.

6. An image processing apparatus comprising:
a signal processor configured to process an image signal comprising a plurality of color components; and
a controller configured to control the signal processor:
to perform a color gamut conversion, a domain transform, a quantization processing and an encoding processing with respect to an input image signal, and
in response to a high frequency component of the image signal exceeding a first critical level, to not perform the color gamut conversion.

7. The apparatus according to claim 6, wherein the controller is configured to, in response to differences between the color components of the image signal being less than a second critical level,
control the signal processor to not to perform the color gamut conversion, and to perform the quantization processing without performing the color gamut conversion.

8. The apparatus according to claim 7, wherein the controller is configured to,
in response to the high frequency component of the image signal exceeding a third critical level lower than the first critical level and the differences between the color components of the image signal being less than a fourth critical level higher than the second critical level,
control the signal processor to not perform the color gamut conversion, and to perform the quantization processing without performing the color gamut conversion.

9. The apparatus according to claim 6, wherein the controller is configured to control the signal processor to, in response to the high frequency component of the image signal exceeding the first critical level,
perform a test for the color gamut conversion, and
determine whether to perform the color gamut conversion based on at least one of: a compression ratio and a signal to noise ratio of the image signal as a result of the performed test.

10. The apparatus according to claim 6, further comprising:
a communicator comprising communication circuitry configured to communicate with an external apparatus,
wherein the controller is configured to control the communicator to transmit the image signal to which the encoding processing is performed, to the external apparatus.

11. A method of controlling an image processing apparatus comprising a signal processor configured to process an image signal having a plurality of color components, the method comprising:
performing, by the signal processor, a color gamut conversion, a domain transform, a quantization processing and an encoding processing with respect to an input image signal; and
in response to differences between the color components of the image signal being less than a first critical level, controlling the signal processor to not perform the color gamut conversion.

12. The method according to claim 11, further comprising:
in response to a high frequency component of the image signal exceeding a second critical level, performing the quantization processing without performing the color gamut conversion.

13. The method according to claim 12, further comprising:
in response to the differences between the color components of the image signal being less than a third critical level higher than the first critical level and the high frequency component of the image signal exceeding a fourth critical level lower than the second critical level,
performing the quantization processing without performing the color gamut conversion.

14. The method according to claim 11, further comprising:
in response to the differences between the color components of the image signal exceeding the first critical level, performing a test for the color gamut conversion; and
determining whether to perform the color gamut conversion based on at least one of: a compression ratio and a signal to noise ratio of the image signal as a result of the performed test.

15. The method according to claim 11, further comprising:
transmitting the image signal to which the encoding processing is performed, to an external apparatus.

16. A method of controlling an image processing apparatus comprising a signal processor configured to process an image signal having a plurality of color components, the method comprising:
performing, by the signal processor, a color gamut conversion, a domain transform, a quantization processing and an encoding processing with respect to an input image signal; and
in response to a high frequency component of the image signal exceeding a first critical level,
controlling the signal processor to not perform the color gamut conversion.

17. The method according to claim 16, further comprising:
in response to differences between the color components of the image signal being less than a second critical level,
performing the quantization processing without performing the color gamut conversion.

18. The method according to claim 16, further comprising:
in response to the high frequency component of the image signal exceeding a third critical level lower than the first critical level and the differences between the color components of the image signal being less than a fourth critical level higher than the second critical level,
performing the quantization processing without performing the color gamut conversion.

19. The method according to claim 16, further comprising:
in response to the high frequency component of the image signal exceeding the first critical level,
performing a test for the color gamut conversion; and
determining whether to perform the color gamut conversion based on at least one of: a compression ratio and a signal to noise ratio of the image signal as a result of the performed test.

20. The method according to claim 16, further comprising:
transmitting the image signal to which the encoding processing is performed, to an external apparatus.
